(19) United States
(12) Patent Application Publication
(10) Pub. No.: US 2012/0164316 A1
(43) Pub. Date: Jun. 28, 2012

(54) Method for Producing Resin-Impregnated Sheet

(75) Inventors: Takeshi KONDO, Tsukuba-shi (JP); Ryo MIYAKOSHI, Tsukuba-shi (JP); Toyonari ITO, Tsukuba-shi (JP)

(73) Assignee: SUMITOMO CHEMICAL COMPANY, LIMITED, Tokyo (JP)

(21) Appl. No.: 13/303,942

(22) Filed: Nov. 23, 2011

(30) Foreign Application Priority Data
Dec. 27, 2010 (JP) 2010-289625

(51) Int. Cl. B05D 5/12

(52) U.S. Cl. 427/121

(57) ABSTRACT

An object of the present invention is to produce a resin-impregnated sheet in which a fiber sheet is impregnated with a liquid crystal polyester, which has excellent thermal conductivity in a thickness direction. A resin-impregnated sheet is produced by impregnating a fiber sheet with a liquid composition containing a liquid crystal polyester and a solvent; removing the solvent; raising a temperature from a temperature of 150° C. or lower to a temperature of a liquid crystal transition temperature or higher of the liquid crystal polyester at a rate of 1.0° C./minute or more; and then heat-treating the obtained resin-impregnated sheet at a temperature of the liquid crystal transition temperature or higher of the liquid crystal polyester.

### BACKGROUND OF THE INVENTION

(1) Field of the Invention

The present invention relates to a method for producing a resin-impregnated sheet in which a fiber sheet is impregnated with a liquid crystal polyester.

(2) Description of Related Art

Since a liquid crystal polyester has high heat resistance and low dielectric loss, use of a resin-impregnated sheet in which a fiber sheet is impregnated with a liquid crystal polyester, as an insulating layer of a printed circuit board, has been examined. It has also been examined, as a method for producing the same, a method in which a fiber sheet is impregnated with a liquid composition containing a liquid crystal polyester and a solvent, and then the solvent is removed and the obtained resin-impregnated sheet is heat-treated. For example, JP-A-2004-244621 discloses that a resin-impregnated sheet is obtained using a liquid crystal polyester having a liquid crystal transition temperature of 350° C. and then heat-treated at 300° C. JP-A-2005-194406 discloses that a resin-impregnated sheet is obtained using a liquid crystal polyester having a liquid crystal transition temperature of 350° C. and then heat-treated at 320° C. JP-A-2006-1959 discloses that a resin-impregnated sheet is obtained using a liquid crystal polyester having a liquid crystal transition temperature of 370° C. and then heat-treated at 300° C.

### SUMMARY OF THE INVENTION

Thermal conductivity in a thickness direction of the resin-impregnated sheets in which a fiber sheet is impregnated with a liquid crystal polyester, obtained by the methods disclosed in JP-A-2004-244621, JP-A-2005-194406 and JP-A-2006-1959, is not necessarily satisfactory. Thus, an object of the present invention is to provide a method capable of producing a resin-impregnated sheet in which a fiber sheet is impregnated with a liquid crystal polyester, and the resin-impregnated sheet having excellent thermal conductivity in a thickness direction.

In order to achieve the object, the present invention provides a method for producing a resin-impregnated sheet, which comprises impregnating a fiber sheet with a liquid composition containing a liquid crystal polyester and a solvent; removing the solvent; raising a temperature from a temperature of 150° C. or lower to a temperature of a liquid crystal transition temperature or higher of the liquid crystal polyester at a rate of 1.0° C./minute or more; and then heat-treating the obtained resin-impregnated sheet at a temperature of the liquid crystal transition temperature or higher of the liquid crystal polyester.

According to the present invention, it is possible to obtain a resin-impregnated sheet in which a fiber sheet is impregnated with a liquid crystal polyester, and the resin-impregnated sheet having excellent thermal conductivity in a thickness direction.

### DETAILED DESCRIPTION OF PREFERRED EMBODIMENTS

The liquid crystal polyester is a liquid crystal polyester which exhibits mesomorphism in a molten state, and is preferably melted at a temperature of 450° C. or lower. The liquid crystal polyester may be a liquid crystal polyester amide, a liquid crystal polyester ether, a liquid crystal polyester carbonate, or a liquid crystal polyester imide. The liquid crystal polyester is preferably a wholly aromatic liquid crystal polyester obtained by using only an aromatic compound as a raw monomer.

Typical examples of the liquid crystal polyester include those obtained by polymerization (polycondensation) of an aromatic hydroxycarboxylic acid, an aromatic dicarboxylic acid, and at least one kind of compound selected from the group consisting of an aromatic diol, an aromatic hydroxyamine and an aromatic diamine; those obtained by polymerization of plural kinds of aromatic hydroxycarboxylic acids; those obtained by polymerization of an aromatic dicarboxylic acid, and at least one kind of compound selected from the group consisting of an aromatic diol, an aromatic hydroxyamine and an aromatic diamine; and those obtained by polymerization of a polyester such as polyethylene terephthalate, and an aromatic hydroxycarboxylic acid. Herein, there may, be used a polymerizable derivative thereof in place of a part or all of the aromatic hydroxycarboxylic acid, aromatic dicarboxylic acid, aromatic diol, aromatic hydroxyamine and aromatic diamine, each independently.

Examples of the polymerizable derivative of the compound having a carboxyl group such as an aromatic hydroxycarboxylic acid or aromatic dicarboxylic acid include those obtained by converting a carboxyl group into an alkoxycarbonyl group or an aryloxycarbonyl group (ester); those obtained by converting a carboxyl group into a haloformyl group (acid halide); and those obtained by converting a carboxyl group into an acyloxycarbonyl group (acid anhydride). Examples of the polymerizable derivative of the compound having a hydroxyl group such as an aromatic hydroxycarboxylic acid, an aromatic diol or an aromatic hydroxylamine include those obtained by converting a hydroxyl group into an acyloxyl group through acylation (acylated product). Examples of the polymerizable derivative of the compound having an amino group such as an aromatic hydroxyamine or an aromatic diamine include those obtained by converting an amino group into an acylamino group through acylation (acylated product).

The liquid crystal polyester preferably includes a repeating unit represented by the following formula (1) (hereinafter may be sometimes referred to as a “repeating unit (1)”), and more preferably includes the repeating unit (1), a repeating unit represented by the following formula (2) (hereinafter may be sometimes referred to as a “repeating unit (2)”) and a repeating unit represented by the following formula (3) (hereinafter may be sometimes referred to as a “repeating unit (3)):

—O—Ar¹—CO—, (1)

—CO—Ar²—CO—, (2) and

—X—Ar³—Y— (3)

wherein Ar¹ represents a phenylene group, a naphthylene group or a biphenylylene group; Ar² and Ar³ each independently represents a phenylene group, a naphthylene group, a biphenylylene group or a group represented by the following formula (4); X and Y each independently represents an oxygen atom or an imino group (—NH—); and hydrogen atoms existing in the group represented by Ar¹, Ar² or Ar³ each independently may be substituted with a halogen atom, an alkyl group or an aryl group, and

—Ar⁴—Z—Ar⁵— (4)

wherein Ar⁴ and Ar⁵ each independently represents a phenylene group or a naphthylene group; and Z represents an oxygen atom, a sulfur atom, a carbonyl group, a sulfonyl group or an alkylidene group.

Examples of the halogen atom include a fluorine atom, a chlorine atom, a bromine atom and an iodine atom. Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group and an n-decyl group, and the number of carbon atoms is usually from 1 to 10. Examples of the aryl group include a phenyl group, an o-tolyl group, an m-tolyl group, a p-tolyl group, a 1-naphthyl group and a 2-naphthyl group, and the number of carbon atoms is usually from 6 to 20. When the hydrogen atom is substituted with these groups, the number thereof is independently usually 2 or less, and preferably 1 or less, respectively, every group represented by Ar¹, Ar² or Ar³.

Examples of the alkylidene group include a methylene group, an ethylidene group, an isopropylidene group, an n-butylidene group and a 2-ethylhexylidene group, and the number of carbon atoms is usually from 1 to 10.

The repeating unit (1) is a repeating unit derived from a predetermined aromatic hydroxycarboxylic acid. The repeating unit (1) is preferably a repeating unit in which Ar¹ is a p-phenylene group (a repeating unit derived from a p-hydroxybenzoic acid), or a repeating unit in which Ar¹ is a 2,6-naphthylene group (a repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar² is a p-phenylene group (a repeating unit derived from terephthalic acid), a repeating unit in which Ar² is a m-phenylene group (a repeating unit derived from isophthalic acid), a repeating unit in which Ar² is a 2,6-naphthylene group (a repeating unit derived from 6-hydroxy-2-naphthoic acid), or a repeating unit in which Ar² is a diphenylether-4,4′-diyl group (a repeating unit derived from diphenylether-4,4′-dicarboxylic acid).

The repeating unit (3) is a repeating unit derived from a predetermined aromatic diol, an aromatic hydroxylamine or an aromatic diamine. The repeating unit (3) is preferably a repeating unit in which Ar³ is a p-phenylene group (a repeating unit derived from hydroquinone, p-aminophenol or p-phenylenediamine), or a repeating unit in which Ar³ is a 4,4′-biphenylylene group (a repeating unit derived from 4,4′-dihydroxybiphenyl, 4-amino-4′-hydroxybiphenyl or 4,4′-diaminobiphenyl).

The content of the repeating unit (1) is usually 30 mol % or more, preferably 30 to 80 mol %, more preferably from 30 to 60 mol %, and still more preferably from 30 to 40 mol %, based on the total amount of all repeating units (value in which the mass of each repeating unit constituting a liquid crystal polyester is divided by a formula weight of each repeating unit thereof to determine the amount (mol) corresponding to the amount of a substance of each repeating unit, and then the obtained amounts are totaled). The content of the repeating unit (2) is usually mol % or less, preferably from 10 to 35 mol %, more preferably from 20 to 35 mol %, and still more preferably from 30 to 35 mol %, based on the total amount of all repeating units. The content of the repeating unit (3) is usually 35 mol % or less, preferably from 10 to 35 mol %, more preferably from 20 to 35 mol %, and still more preferably from 30 to 35 mol %, based on the total amount of all repeating units. As the content of the repeating unit (1) increases, heat resistance as well as strength and rigidity are likely to be improved. However, when the content is too large, solubility of the liquid crystal polyester in a solvent is likely to decrease.

A ratio of the content of the repeating unit (2) to the content of the repeating unit (3) is usually from 0.9/1 to 1/0.9, preferably from 0.95/1 to 1/0.95, and more preferably from 0.98/1 to 1/0.98, in terms of [content of the repeating unit (2)]/[content of the repeating unit (3)] (mol/mol).

The liquid crystal polyester may include two or more kinds of each of the repeating units (1) to (3), independently. The liquid crystal polyester may include the repeating unit other than the repeating units (1) to (3), and the content thereof is usually 10 mol % or less, and preferably 5 mol % or less, based on the total amount of all repeating units.

The liquid crystal polyester preferably includes, as the repeating unit (3), a repeating unit in which X and/or Y is/are imino group(s), that is, a repeating unit derived from a predetermined aromatic hydroxylamine and/or a repeating unit derived from aromatic diamine, because of excellent solubility in a solvent, and more preferably includes, as the repeating unit (3), only a repeating unit in which X and/or Y is/are imino group(s).

The liquid crystal polyester is preferably produced by melt-polymerizing a raw monomer corresponding to a repeating unit constituting the liquid crystal polyester. The melt polymerization may be carried out in the presence of a catalyst, and examples of the catalyst include metal compounds such as magnesium acetate, stannous acetate, tetrabutyl titanate, lead acetate, sodium acetate, potassium acetate and antimony trioxide; and nitrogen-containing heterocylic compounds such as 4-(dimethylamino)pyridine and 1-methylimidazol. Among these catalysts, nitrogen-containing heterocylic compounds are preferably used. The melt polymer product may be further subjected to solid-phase polymerization, optionally.

The liquid crystal transition temperature of the thus obtained liquid crystal polyester used as a raw material in the present invention is preferably 320° C. or lower, more preferably from 150 to 320° C., still more preferably from 150 to 300° C., and particularly preferably from 150 to 280° C. As the liquid crystal transition temperature of the liquid crystal polyester decreases, thermal conductivity in a thickness direction of the resin-impregnated sheet after the heat treatment may be improved. However, when the liquid crystal transition temperature is too low, heat resistance as well as strength and rigidity of the resin-impregnated sheet are likely to become insufficient even after the heat treatment.

The liquid crystal transition temperature is also called a liquid crystallization temperature, and is a temperature at which a Schlieren pattern is exhibited when the liquid crystal polyester is melted under crossed nicol using a polarization microscope while raising a temperature at a rate of 10° C./minute.

The flow initiation temperature of the thus obtained liquid crystal polyester used as a raw material in the present invention is preferably 260° C. or lower, more preferably from 120 to 260° C., still more preferably from 150 to 250° C., and particularly preferably from 150 to 220° C. As the flow initiation temperature of the liquid crystal polyester decreases, the thermal conductivity in a thickness direction of the resin-impregnated sheet after the heat treatment may be improved. However, when the flow initiation temperature is too low, heat resistance, strength as well as rigidity of the resin-impregnated sheet are likely to become insufficient even after the heat treatment.

The flow initiation temperature is also called a flow temperature and means a temperature at which a melt viscosity becomes 4,800 Pa·s (48,000 poise) when a liquid crystal polyester is melted while heating at a heating rate of 4° C./min under a load of 9.8 MPa (100 kg/cm²) and extruded through a nozzle having an inner diameter of 1 mm and a length of 10 mm using a capillary rheometer, and the flow initiation temperature serves as an index indicating molecular weight of the liquid crystal polyester (see “Liquid Crystalline Polymer—Synthesis, Molding, and Application” edited by Naoyuki Koide, page 95, CMC Publishing CO., LTD., issued on Jun. 5, 1987).

The weight average molecular weight of the thus obtained liquid crystal polyester used as a raw material in the present invention is preferably 13,000 or less, more preferably from 3,000 to 13,000, still more preferably from 5,000 to 12,000, and particularly preferably from 5,000 to 10,000. As weight average molecular weight of the liquid crystal polyester decreases, thermal conductivity in a thickness direction of the resin-impregnated sheet after the heat treatment may be improved. However, when the weight average molecular weight is too small, heat resistance, strength as well as rigidity of the resin-impregnated sheet are likely to become insufficient even after the heat treatment.

The weight average molecular weight can be measured by gel permeation chromatography (GPC).

A liquid composition is obtained by dissolving or dispersing the thus obtained liquid crystal polyester in a solvent, and preferably dissolving in a solvent. It is possible to use, as the solvent, a solvent in which the liquid crystal polyester to be used is soluble or dispersible, preferably a solvent in which the liquid crystal polyester to be used is soluble, and specifically a solvent which is soluble in the concentration ([liquid crystal polyester]/[liquid crystal polyester+solvent]) of 1% by mass or more at 50° C., by appropriate selection.

Examples of the solvent include halogenated hydrocarbons such as dichloromethane, chloroform, 1,2-dichloroethane, 1,1,2,2,-tetrachloroethane and o-dichlorobenzene; phenol halides such as p-chlorophenol, pentachlorophenol and pentafluorophenol; ethers such as diethylether, tetrahydrofuran and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amides such as N,N-dimethylformamide, N,N-dimethylacetamide and N-methylpyrrolidone, urea compounds such as tetramethylurea; nitro compounds such as nitromethane and nitrobenzene; sulfur compounds such as dimethyl sulfoxide and sulfolane; and phosphorus compounds such as hexamethylphosphoric acid amide and tri-n-butylphosphoric acid. Two or more kinds of these solvents may be used.

The solvent is preferably a solvent containing, as a main component, an aprotic compound, and particularly an aprotic compound having no halogen atom, since the solvent is easily handled because of low corrosion resistance. The content of the aprotic compound in the entire solvent is preferably from 50 to 100% by mass, more preferably from 70 to 100% by mass, and still more preferably from 90 to 100% by mass. It is preferred to use, as the aprotic compound, amides such as N,N-dimethylformamide, N,N-dimethylacetamide and N-methylpyrrolidone since it is easy to dissolve the liquid crystal polyester.

The solvent is preferably a solvent containing, as a main component, a compound having a dipole moment of 3 to 5 since it is easy to dissolve the liquid crystal polyester. The content in the entire solvent of the compound having a dipole moment of 3 to 5 is preferably 50 to 100% by mass, more preferably from 70 to 100% by mass, and still more preferably from 90 to 100% by mass. It is preferred to use, as the aprotic compound, a compound having a dipole moment of 3 to 5.

The solvent is preferably a solvent containing, as a main component, a compound having a boiling point at 1 atom of 220° C. or lower since it is easy to remove. The content in the entire solvent of the compound having a boiling point at 1 atom of 220° C. or lower is preferably from 50 to 100% by mass, more preferably from 70 to 100% by mass, and still more preferably from 90 to 100% by mass. It is preferred to use, as the aprotic compound, a compound having a boiling point at 1 atom of 220° C. or lower.

The content of the liquid crystal polyester in the liquid composition is usually from 5 to 60% by mass, preferably from 10 to 50% by mass, and more preferably from 15 to 45% by mass, based on the total amount of the liquid crystal polyester and solvent, and the content is appropriately adjusted so as to obtain a liquid composition having a desired viscosity and to impregnate a fiber sheet with a desired amount of a liquid crystal polyester.

The liquid composition may contain one or more kinds of other components such as a filler, an additive, and a resin other than the liquid crystal polyester.

Examples of the filler include inorganic fillers such as silica, alumina, zinc oxide, titanium oxide, tin oxide, aluminum nitride, boron nitride, silicon nitride and silicon carbide; and organic fillers such as a hardened epoxy resin, a crosslinked benzoguanamine resin and a crosslinked acrylic resin, and two or more kinds of them may be optionally used. Among these fillers, inorganic fillers are preferably used since thermal conductivity of the resin-impregnated sheet is likely to be improved. The content of the filler is usually from 0 to 80% by volume, preferably from 5 to 60% by volume, and more preferably from 10 to 50% by volume, based on the total amount of the liquid crystal polyester and the filler.

Examples of the additive include a leveling agent, a defoamer, an antioxidant, an ultraviolet absorber, a flame retardant and a coloring agent. The content thereof is usually from 0 to 5 parts by mass based on 100 parts by mass of the liquid crystal polyester.

Examples of the resin other than the liquid crystal polyester include thermoplastic resins other than the liquid crystal polyester, such as polypropylene, polyamide, polyester other than the liquid crystal polyester, polyphenylene sulfide, polyetherketone, polycarbonate, polyethersulfone, polyphenyleneether and polyetherimide; and thermosetting resins such as a phenol resin, an epoxy resin, a polyimide resin and a cyanate resin. The content thereof is usually from 0 to 20 parts by mass based on 100 parts by mass of the liquid crystal polyester.

The liquid composition can be prepared by mixing a liquid crystal polyester, a solvent, and other component to be optionally used, collectively or in a suitable order. When the filler is used as other components, the liquid composition is preferably prepared by dissolving the liquid crystal polyester in the solvent to obtain a liquid crystal polyester solution, and then dispersing a filler in this liquid crystal polyester solution.

After impregnating a fiber sheet with the thus obtained liquid composition, the solvent is removed from the liquid composition and the obtained resin-impreganted sheet is heat-treated.

Examples of the fiber constituting the fiber sheet include inorganic fibers such as a glass fiber, a carbon fiber and a ceramic fiber; and organic fibers such as a polyester fiber (e.g., liquid crystal polyester fiber, etc.), an aramid fiber and a polybenzazole fiber, and two or more kinds of them may be used. Among these fibers, a glass fiber is preferable.

The fiber sheet may be a textile fabric (woven fabric), a knit fabric or a nonwoven fabric, and is preferably a textile fabric since it is easy to improve dimensional stability of a liquid crystal polyester-impregnated fiber sheet.

The thickness of the fiber sheet is usually from 10 to 100 μm, preferably from 10 to 90 μm, and more preferably from 10 to 70 μm.

Impregnation of the fiber sheet with a liquid composition is typically carried out by immersing the fiber sheet in an immersion tank charged with the liquid composition. It is possible to adjust the amount of the liquid crystal polyester with which the fiber sheet is impregnated by appropriately adjusting the time of the fiber sheet to be impregnated and the rate of taking up the fiber sheet impregnated with the liquid composition from an immersion tank according to the content of the liquid crystal polyester in the liquid composition. The amount of the liquid crystal polyester with which the fiber sheet is impregnated is preferably from 30 to 80% by mass, and more preferably from 40 to 70% by mass, based on the entire mass of the obtained liquid crystal polyester-impregnated fiber sheet.

The solvent is preferably removed by vaporization since it is easy to operate. Examples of the method include heating, decompression and ventilation methods, and these methods may be used in combination. Above all, removal of the solvent is preferably carried out by heating, and more preferably heating while ventilating, from the viewpoint of productivity and operability. The temperature at which the solvent is removed is usually from 20 to 200° C., and preferably from 40 to 150° C. The time required to remove the solvent is usually from 1 to 120 minutes, and preferably from 5 to 60 minutes. The solvent may not be completely removed, and the residual solvent may be removed by the subsequent heat treatment.

In the present invention, the temperature is raised from a temperature of 150° C. or lower to a temperature of a liquid crystal transition temperature or higher of the liquid crystal polyester as the raw material at a rate of 1.0° C./minute or more, and then the resin-impregnated sheet obtained by removal of the solvent is heat-treated at a temperature of a liquid crystal transition temperature or higher of the liquid crystal polyester as the raw material. Whereby, it is possible to obtain a resin-impregnated sheet having excellent thermal conductivity in a thickness direction.

The temperature increase rate is preferably 3.0° C./minute or more, more preferably 6.0° C./minute or more, and still more preferably 8.0° C./minute or more, and also it is usually 50° C./minute or less, and preferably 20° C./minute or less. As the temperature increase rate increases, the thermal conductivity in a thickness direction of the resin-impregnated sheet after a heat treatment may be improved. However, when the temperature increase rate is too high, it is difficult to be controlled, and thus the liquid crystal polyester may be likely to be decomposed or the film may be likely to undergo foaming.

The temperature is preferably raised from a temperature of 120° C. or lower, and more preferably from a temperature of 100° C. or lower, at the above rate. The temperature is preferably raised to a temperature of the liquid crystal transition temperature+10° C. or higher, and more preferably to a temperature of the liquid crystal transition temperature+20° C. or higher.

The heat treatment at the liquid crystal transition temperature or higher is preferably carried out at the liquid crystal transition temperature+10° C. to the liquid crystal transition temperature+80° C., and more preferably the liquid crystal transition temperature+20° C. to the liquid crystal transition temperature+60° C. The time of the heat treatment at the liquid crystal transition temperature or higher is usually from 0.5 to 10 hours, and preferably from 2 to 4 hours.

It is possible to obtain a resin-impregnated sheet with a conductor layer by optionally laminating a plurality of the thus obtained resin-impregnated sheets and then forming the conductor layer on at least one surface of the resin-impregnated sheet.

The conductor layer may be formed by bonding a metal foil using an adhesive, or laminating through welding using hot pressing. The conductor layer may be formed by coating metal particles using a plating method, a screen printing method, a sputtering method and the like. Examples of the metal constituting metal foil or metal particle include copper, aluminum and silver. Copper is preferably used from the viewpoint of conductivity and cost.

The thus obtained resin-impregnated sheet with a conductor layer can be suitably used as a printed circuit board including a resin-impregnated sheet as an insulating layer by forming a predetermined wiring pattern on the conductor layer, and then optionally laminating a plurality of resin-impregnated sheets.

### EXAMPLES

### [Measurement of Liquid Crystal Transition Temperature of Liquid Crystal Polyester]

On a heating stage of a polarization microscope, a liquid crystal polyester was placed and the liquid crystal polyester was melted under crossed nicol while raising a temperature at a rate of 10° C./minute, and then the temperature, at which a Schlieren pattern is exhibited, was measured. When the liquid crystal polyester was not completely melted under still standing, the liquid crystal polyester was completely melted under pressurization by spring pressure.

### [Measurement of Flow Initiation Temperature of Liquid Crystal Polyester]

Using a flow tester (“Model “CFT-500”, manufactured by Shimadzu Corporation), about 2 g of a liquid crystal polyester was filled into a cylinder attached with a die including a nozzle measuring 1 mm in inner diameter and 10 mm in length. Under a load of 9.8 MPa (100 kg/cm²), a liquid crystal polyester was melted while raising a temperature at a rate of 4° C./minute, the molten liquid crystal polyester was extruded through the nozzle and then a temperature, at which a viscosity of 4,800 Pa·s (48,000 poise) is exhibited, was measured.

### [Measurement of Weight Average Molecular Weight of Liquid Crystal Polyester]

The polystyrene-equivalent weight average molecular weight was measured by gel permeation chromatography (GPC) under the following conditions.

Apparatus: “HLC-8120GPC”, manufactured by TOSOH CORPORATION
Sample: N-methylpyrrolidone solution having a concentration of 0.5% by mass of a liquid crystal polyester Injection amount of sample: 100 μl
Column: “α-M” and “α-3000” manufactured by TOSOH CORPORATION are connected
Mobile phase: N-methylpyrrolidone solution having a concentration of 50 mmol/L of lithium bromide
Flow rate of mobile phase: 0.7 ml/minute
Detector: UV-Visible detectors (manufactured by TOSOH CORPORATION under the trade name of UV-8020)

### [Measurement of Thermal Conductivity in Thickness Direction of Liquid Crystal Polyester Film]

The thermal conductivity was calculated by the following equation: Thermal conductivity=thermal diffusivity×specific heat×density. The thermal diffusivity was measured at room temperature by temperature wave analysis (sample size: 10 mm×10 mm×1 mm) using “ai-Phase Mobile” manufactured by ai-Phase Co., Ltd. The specific heat was measured by a comparison with a sapphire standard substance using differential scanning calorimetry (DSC). The density was measured by an Archimedian method. Production Example 1 (Production of Liquid Crystal Polyester (1))

In a reactor equipped with a stirrer, a torque meter, a nitrogen gas introducing tube, a thermometer and a reflux condenser, 1,976 g (10.5 mol) of 6-hydroxy-2-naphthoic acid, 1,474 g (9.75 mol) of 4-hydroxyacetoanilide, 1,620 g (9.75 mol) of isophthalic acid and 2,374 g (23.25 mol) of acetic anhydride were charged, and the gas in the reactor was replaced by a nitrogen gas. After raising a temperature from room temperature to 150° C. over 15 minutes while stirring under a nitrogen gas flow, the mixture was refluxed at 150° C. for 3 hours. Next, a temperature was raised from 150° C. to 300° C. over 2 hours and 50 minutes while distilling off the by-produced acetic acid and the unreacted acetic anhydride. At the point of time when the temperature reached 300° C., contents were taken out from the reactor and then cooled to room temperature. The obtained solid was crushed by a crusher to obtain a powdered liquid crystal polyester (1). The obtained liquid crystal polyester (1) showed a liquid crystal transition temperature of 260° C., a flow initiation temperature of 180° C. and a weight average molecular weight of 7,000. Production Example 2 (Production of Liquid Crystal Polyester (2))

In a reactor equipped with a stirrer, a torque meter; a nitrogen gas introducing tube, a thermometer and a reflux condenser, 1,976 g (10.5 mol) of 6-hydroxy-2-naphthoic acid, 1,474 g (9.75 mol) of 4-hydroxyacetoanilide, 1,620 g (9.75 mol) of isophthalic acid and 2,374 g (23.25 mol) of acetic anhydride were charged, and the gas in the reactor was replaced by a nitrogen gas. After raising a temperature from room temperature to 150° C. over 15 minutes while stirring under a nitrogen gas flow, the mixture was refluxed at 150° C. for 3 hours. Next, a temperature was raised from 150° C. to 300° C. over 2 hours and 50 minutes while distilling off the by-produced acetic acid and the unreacted acetic anhydride. After maintaining at 300° C. for 1 hour, contents were taken out from the reactor and then cooled to room temperature. The obtained solid was crushed by a crusher. Next, a temperature was raised from room temperature to 223° C. over 6 hours under a nitrogen gas atmosphere. Then, the resultant was heated at 223° C. for 3 hours for solid-phase polymerization, and cooled to obtain a powdered liquid crystal polyester (2). The obtained liquid crystal polyester (2) showed a liquid crystal transition temperature of 340° C., a flow initiation temperature of 273° C. and a weight average molecular weight of 17,000.

### Example 1

The liquid crystal polyester (1) (2,200 g) was added to 7,800 g of N,N-dimethylacetamide, followed by heating at 100° C. for 2 hours to obtain a liquid crystal polyester solution. A glass cloth (manufactured by Arisawa Mfg. Co., Ltd., thickness of 50 μm) was immersed in the obtained solution and then the solvent was vaporized at 160° C. using a hot air dryer. Using the hot air dryer, the temperature was raised from 40° C. to 300° C. at a rate of 9.0° C./minute under a nitrogen gas atmosphere and then maintained at 300° C. for 3 hours. The obtained resin-impregnated sheet showed the amount of the liquid crystal polyester with which the sheet is impregnated of 52% by mass, and a thickness of 46 μm. The thermal conductivity in a thickness direction of the resin-impregnated sheet was measured. The results are shown in Table 1.

### Example 2

To the liquid crystal polyester solution obtained in Example 1, a spherical α-alumina powder (“Sumicorundum AA-03”, manufactured by Sumitomo Chemical Co. Ltd., volume average particle diameter of 0.3 μm) was added in the amount of 20% by volume based on the total amount of the liquid crystal polyester and the spherical α-alumina powder, followed by degassing under stirring for 5 minutes using a centrifugal bubble eliminator to obtain a liquid composition. A glass cloth (manufactured by Arisawa Mfg. Co., Ltd., thickness of 50 μm) was immersed in the obtained liquid composition and then the solvent was vaporized at 160° C. using a hot air dryer. Using the hot air dryer, the temperature was raised from 40° C. to 300° C. under a nitrogen gas atmosphere at a rate of 9.0° C./minute, and then maintained at 300° C. for 3 hours. The obtained resin-impregnated sheet showed that the total amount of the liquid crystal polyester and the spherical α-alumina powder, with which the resin-impregnated sheet is impregnated, was 74% by mass, and also showed a thickness of 89 μm. The thermal conductivity in a thickness direction of the resin-impregnated sheet was measured. The results are shown in Table 1.

### Example 3

In the same manner as in Example 2, except that the amount of the spherical α-alumina powder added to the liquid crystal polyester solution was changed from 20% by volume to 40% by volume based on the total amount of the liquid crystal polyester and the spherical α-alumina powder, a resin-impregnated sheet was obtained. The obtained resin-impregnated sheet showed that the total amount of the liquid crystal polyester and the spherical α-alumina powder, with which the resin-impregnated sheet is impregnated, was 83% by mass, and also showed a thickness of 110 μm. The thermal conductivity in a thickness direction of the resin-impregnated sheet was measured. The results are shown in Table 1.

### Comparative Example 1

In the same manner as in Example 1, except that the liquid crystal polyester (2) was used in place of the liquid crystal polyester (1), a resin-impregnated sheet was obtained. The obtained resin-impregnated sheet showed that the amount of the liquid crystal polyester, with which the resin-impregnated sheet is impregnated, was 60% by mass, and also showed a thickness of 49 μm. The thermal conductivity in a thickness direction of the resin-impregnated sheet was measured. The results are shown in Table 1.

### Comparative Example 2

In the same manner as in Example 2, except that the liquid crystal polyester (2) was used in place of the liquid crystal polyester (1), a resin-impregnated sheet was obtained. The obtained resin-impregnated sheet showed that the total amount of the liquid crystal polyester and the α-alumina powder, with which the resin-impregnated sheet is impregnated, was 78% by mass, and also showed a thickness of 89 μm. The thermal conductivity in a thickness direction of the resin-impregnated sheet was measured. The results are shown in Table 1.

### Comparative Example 3

In the same manner as in Example 3, except that the liquid crystal polyester (2) was used in place of the liquid crystal polyester (1), a resin-impregnated sheet was obtained. The obtained resin-impregnated sheet showed that the total amount of the liquid crystal polyester and the α-alumina powder, with which the resin-impregnated sheet is impregnated, was 84% by mass, and also showed a thickness of 108 μm. The thermal conductivity in a thickness direction of the resin-impregnated sheet was measured. The results are shown in Table 1.

### Comparative Example 4

In the same manner as in Comparative Example 3, except that the rate of raising the temperature from 40° C. to 300° C. was changed from 9.0° C./minute to 0.5° C./minute, a resin-impregnated sheet was obtained. The obtained resin-impregnated sheet showed that the total amount of the liquid crystal polyester and the α-alumina powder, with which the resin-impregnated sheet is impregnated, was 84% by mass, and also showed a thickness of 108 μm. The thermal conductivity in a thickness direction of the resin-impregnated sheet was measured. The results are shown in Table 1.

TABLE 1

| | | Examples | | | | | | |
|---|---|---|---|---|---|---|---|---|
| | | | | | Comparative | Comparative | Comparative | Comparative |
| | | Example 1 | Example 2 | Example 3 | Example 1 | Example 2 | Example 3 | Example 4 |
| Liquid crystal polyester | (Kind) | (1) | (1) | (1) | (2) | (2) | (2) | (2) |
| Liquid crystal transition | (° C.) | 260 | 260 | 260 | 340 | 340 | 340 | 340 |
| temperature | | | | | | | | |
| Flow initiation | (° C.) | 180 | 180 | 180 | 273 | 273 | 273 | 273 |
| temperature | | | | | | | | |
| Alumina | Volume % | 0 | 20 | 40 | 0 | 20 | 40 | 40 |
| Weight average molecular weight | | 7000 | 7000 | 7000 | 17000 | 17000 | 17000 | 17000 |
| Temperature rise rate | ° C./minute | 9.0 | 9.0 | 9.0 | 9.0 | 9.0 | 9.0 | 0.5 |
| Thickness | (μm) | 46 | 89 | 110 | 49 | 89 | 108 | 108 |
| Thermal conductivity | (w/m · k) | 0.6 | 1.6 | 2.2 | 0.4 | 0.8 | 1.4 | 1.4 |

What is claimed is:

1. A method for producing a resin-impregnated sheet, which comprises impregnating a fiber sheet with a liquid composition containing a liquid crystal polyester and solvent; removing the solvent; raising a temperature from a temperature of 150° C. or lower to a temperature of a liquid crystal transition temperature or higher of the liquid crystal polyester at a rate of 1.0° C./minute or more; and then heat-treating the obtained resin-impregnated sheet at a temperature of the liquid crystal transition temperature or higher of the liquid crystal polyester.

2. The method for producing a resin-impregnated sheet according to claim 1, wherein the liquid crystal polyester is a liquid crystal polyester including a repeating unit represented by the following formula (1), a repeating unit represented by the following formula (2) and a repeating unit represented by the following formula (3):
—O—Ar¹—CO—, (1)
—CO—Ar²—CO—, (2) and
—X—Ar³—Y— (3)
wherein Ar¹ represents a phenylene group, a naphthylene group or biphenylylene group; Ar² and Ar³ each independently represents a phenylene group, a naphthylene group, a biphenylylene group or a group represented by the following formula (4); X and Y each independently represents an oxygen atom or an imino group; and hydrogen atoms existing in the group represented by Ar¹, Ar² or Ar³ each independently may be substituted with a halogen atom, an alkyl group or an aryl group, and
—Ar⁴—Z—Ar⁵— (4)
wherein Ar⁴ and Ar⁵ each independently represents a phenylene group or a naphthylene group; and Z represents an oxygen atom, a sulfur atom, a carbonyl group, a sulfonyl group or an alkylidene group.

3. The method for producing a resin-impregnated sheet according to claim 2, wherein the liquid crystal polyester is a liquid crystal polyester including 30 to 80 mol % of a repeating unit represented by the formula (1), 10 to 35 mol % of a repeating unit represented by the formula (2) and 10 to 35 mol % of a repeating unit represented by the formula (3), based on the total amount of all repeating units constituting the liquid crystal polyester.

4. The method for producing a resin-impregnated sheet according to claim 2, wherein X and/or Y is/are imino group(s).

5. The method for producing a resin-impregnated sheet according to claim 1, wherein the liquid crystal polyester has a liquid crystal transition temperature of 320° C. or lower.

6. The method for producing a resin-impregnated sheet according to claim 1, wherein the liquid crystal polyester has a flow initiation temperature of 260° C. or lower.

7. The method for producing a resin-impregnated sheet according to claim 1, wherein the liquid crystal polyester has a weight average molecular weight of 13,000 or less.

8. The method for producing a resin-impregnated sheet according to claim 1, wherein the liquid composition is a liquid composition containing an inorganic filler.

9. The method for producing a resin-impregnated sheet according to claim 8, wherein the inorganic filler is at least one kind of inorganic filler selected from the group consisting of silica, alumina, zinc oxide, titanium oxide, tin oxide, aluminum nitride, boron nitride, silicon nitride and silicon carbide.

10. The method for producing a resin-impregnated sheet according to claim 1, wherein the fiber sheet is a textile fabric made of a glass fiber.
